(19) United States
(12) Patent Application Publication
(10) Pub. No.: US 2019/0226896 A1
(43) Pub. Date: Jul. 25, 2019

(54) Novel Electronic Gas Meter

(71) Applicant: Feng ZHANG, Ningbo (CN)

(72) Inventor: Feng ZHANG, Ningbo (CN)

(21) Appl. No.: 15/877,216

(22) Filed: Jan. 22, 2018

(51) Int. Cl. G01F 15/075; G01F 1/34; G08B 21/18; H01M 8/0438; H01M 8/04746

(52) U.S. Cl. CPC G01F 15/0755; G01F 1/34; H01M 2250/10; H01M 8/04388; H01M 8/04753; G08B 21/18

(57) ABSTRACT

The utility model provides a novel electronic gas meter, comprising a connecting pipe that internal threads are arranged at front and back ends thereof respectively, an inlet valve connected to the front end of the connecting pipe by threads. The utility model novel electronic gas meter is simple in structure, and achieves detection and transmission between a pressure and a temperature through a Bluetooth module; and an alarm device is provided inside the meter base, and can make an alarm after the pressure changes.

### TECHNICAL FIELD

The present invention relates to a novel electronic gas meter, and specifically relate to a novel electronic gas meter.

### BACKGROUND

With the improvement of living standards and strengthening of environmental awareness, natural gas is widely used in production and living. A gas meter is an important instrument used by gas, and is capable of conveniently knowing how much gas is used, so as to pay fees according to cubic meters of gas consumed monthly. But, the gas meter has a problem that a user cannot grasp usability of the gas in real time, and thus, cannot charge timely, thereby easily causing arrears.

### SUMMARY

To solve the above problem, the present invention provides a novel electronic gas meter.

The present invention has a technical solution that: a novel electronic gas meter comprises a connecting pipe that internal threads are arranged at front and back ends thereof respectively, an inlet valve connected to the front end of the connecting pipe by threads, a meter base connected in a side hole of a middle part of the connecting pipe through threads, and a meter shell connected at a top of the meter base through threads, wherein a compression cap is arranged at a bottom inside the meter base, an O-type sealing ring is arranged above the compression cap, a pressure sensor is arranged above the O-type sealing ring, an electronic component module is arranged above the pressure sensor, a fuel cell is arranged above the electronic component module, a light guide made of a transparent material is arranged on the meter shell at one side of the fuel cell, an indicating lamp is arranged at a bottom inside the meter base below the light guide, a liquid crystal display is arranged at a top of the meter shell, and a protective cover made of a rubber material is cased outside a junction of the meter base and the meter shell; and the electronic component module comprises an embedded processor, a Bluetooth module connected on the embedded processor for transmitting data, a sampling component connected on the embedded processor for connecting the data, the inlet valve connected on the embedded processor for controlling on/off of natural gas, an alarm device connected on the embedded processor for reminding, and the liquid crystal display connected on the embedded processor for displaying a sampling result.

Further, the sampling component comprises the pressure sensor and a temperature sensor.

Further, the fuel cell is connected to the natural gas by stretching a guide pipe outside the compression cap.

Further, the protective cover is made of a rubber material.

Further, the indicating lamp is a blue LED lamp.

Further, a Bluetooth icon is sprayed on a top of the light guide.

Further, the alarm device is arranged on the fuel cell, and is a buzzer.

Further, the O-type sealing ring is made of a rubber material.

Further, the resolution of the liquid crystal display is 480*240.

Further, the light guide is made of transparent glass.

### BENEFICIAL EFFECTS

The utility model novel electronic gas meter of the present invention is simple in structure, and achieves detection and transmission between a pressure and a temperature through a Bluetooth module; and an alarm device is provided inside the meter base, and can make an alarm after the pressure changes.

### BRIEF DESCRIPTION OF THE DRAWINGS

FIG. 1 is a structural schematic diagram of the present invention.

FIG. 2 is a schematic diagram of the present invention.

In Figure, 1—meter base, 2—compression cap, 3-—O-type sealing ring, 4—pressure sensor, 5—electronic component module, 6—connecting pipe, 7—inlet valve, 8—displa, 9—light guide, 10—meter shell, 11—protective cover, 12—indicating lamp, 13—fuel cell.

### DETAILED DESCRIPTION

A detailed description is made below to a novel electronic gas meter of the present invention in combination with drawings.

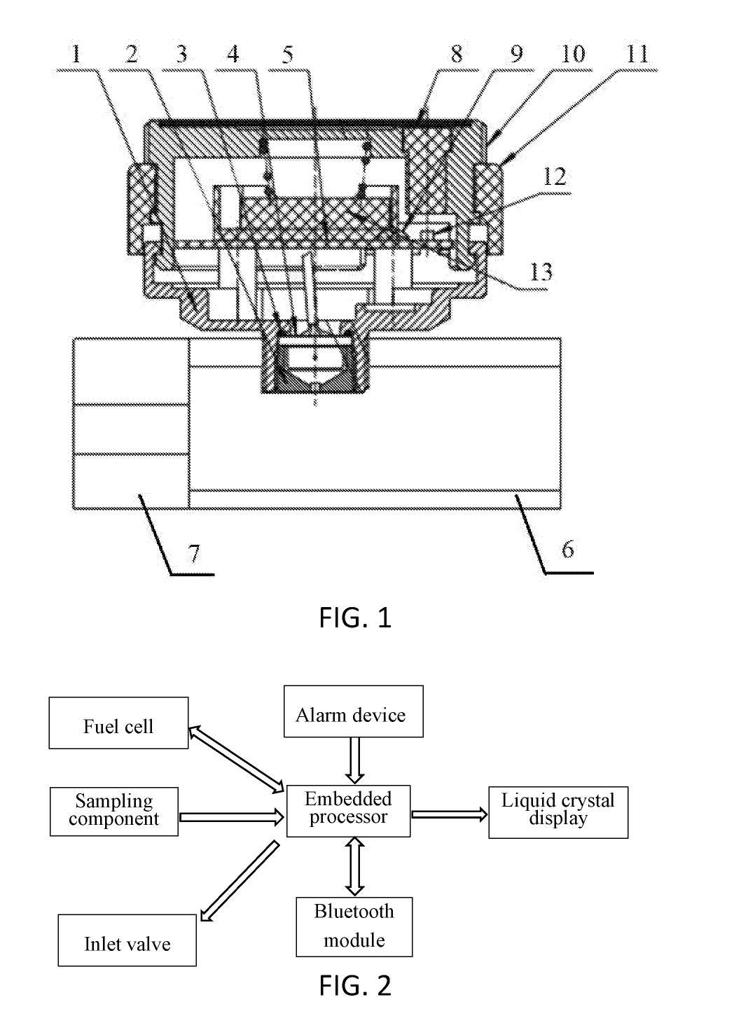

As shown in FIG. 1 and FIG. 2, a novel electronic gas meter comprises a connecting pipe 6 that internal threads are arranged at front and back ends thereof respectively, an inlet valve 7 connected to the front end of the connecting pipe 6 by threads, a meter base 1 connected in a side hole of a middle part of the connecting pipe 6 through threads, and a meter shell 10 connected at a top of the meter base 1 through threads, wherein a compression cap 2 is arranged at a bottom inside the meter base 1, an O-type sealing ring 3 is arranged above the compression cap 2, a pressure sensor 4 is arranged above the O-type sealing ring 3, an electronic component module 5 is arranged above the pressure sensor 4, a fuel cell 13 is arranged above the electronic component module 5, a light guide 9 made of a transparent material is arranged on the meter shell 10 at one side of the fuel cell 13, an indicating lamp 12 is arranged at a bottom inside the meter base 1 below the light guide 9, a liquid crystal display 8 is arranged at a top of the meter shell 10, and a protective cover 11 made of a rubber material is cased outside a junction of the meter base 1 and the meter shell 10; the electronic component module 5 comprises an embedded processor, a Bluetooth module connected on the embedded processor for transmitting data, a sampling component connected on the embedded processor for connecting the data, the inlet valve 7 connected on the embedded processor for controlling on/off of natural gas, an alarm device connected on the embedded processor for reminding, and the liquid crystal display 8 connected on the embedded processor for displaying a sampling result; the sampling component comprises the pressure sensor 4 and a temperature sensor; the fuel cell 13 is connected to the natural gas by stretching a guide pipe outside the compression cap 2; the protective cover 11 is made of a rubber material; the indicating lamp 12 is a blue LED lamp; a Bluetooth icon is sprayed on a top of the light guide 9; the alarm device is arranged on the fuel cell 13, and is a buzzer; the O-type sealing ring 3 is made of a rubber material; the resolution of the liquid crystal display is 480*240; and the light guide 9 is made of transparent glass.

The embodiment said above is only preferred embodiment of the present invention, rather than making any form of limit to the present invention. The present invention has disclosed above with the preferred embodiment, however, it is not used for making definition on the present invention. Some changes or decorations made by any skilled in the art using the technical content disclosed above are equivalent embodiments with an equivalent change, without divorcing from the scope of the technical solution of the present invention, but for all contents which are not divorced from the technical solution of the present invention, any simple amendment made to the above embodiment substantially according to the technology of the present invention is an equivalent change and decoration, both of which still are within the scope of the technical solution of the present invention.

What is claimed is:

1. A novel electronic gas meter, comprising: a connecting pipe that internal threads are arranged at front and back ends thereof respectively, an inlet valve connected to the front end of the connecting pipe by threads, a meter base connected in a side hole of a middle part of the connecting pipe through threads, and a meter shell connected at a top of the meter base through threads, wherein a compression cap is arranged at a bottom inside the meter base, an O-type sealing ring is arranged above the compression cap, a pressure sensor is arranged above the O-type sealing ring, an electronic component module is arranged above the pressure sensor, a fuel cell is arranged above the electronic component module, a light guide made of a transparent material is arranged on the meter shell at one side of the fuel cell, an indicating lamp is arranged at a bottom inside the meter base below the light guide, a liquid crystal display is arranged at a top of the meter shell, and a protective cover made of a rubber material is cased outside a junction of the meter base and the meter shell; and the electronic component module comprises an embedded processor, a Bluetooth module connected on the embedded processor for transmitting data, a sampling component connected on the embedded processor for connecting the data, an inlet valve connected on the embedded processor for controlling on/off of natural gas, an alarm device connected on the embedded processor for reminding, and a liquid crystal display connected on the embedded processor for displaying a sampling result.

2. The novel electronic gas meter according to claim 1, wherein: the sampling component comprises a pressure sensor and a temperature sensor.

3. The novel electronic gas meter according to claim 1, wherein: the fuel cell is connected to the natural gas by stretching a guide pipe outside the compression cap.

4. The novel electronic gas meter according to claim 1, wherein: the protective cover is made of a rubber material.

5. The novel electronic gas meter according to claim 1, wherein: the indicating lamp is a blue LED lamp.

6. The novel electronic gas meter according to claim 1, wherein: a Bluetooth icon is sprayed on a top of the light guide.

7. The novel electronic gas meter according to claim 1, wherein: the alarm device is arranged on the fuel cell, and is a buzzer.

8. The novel electronic gas meter according to claim 1, wherein: the O-type sealing ring is made of a rubber material.

9. The novel electronic gas meter according to claim 1, wherein: the resolution of the liquid crystal display is 480*240.

10. The novel electronic gas meter according to claim 1, wherein: the light guide is made of transparent glass.
